(19) United States
(12) Patent Application Publication
(10) Pub. No.: US 2003/0088931 A1
(43) Pub. Date: May 15, 2003

(54) Hot air welding of toothbrush components

(75) Inventors: Bruce M. Russell, Howell, NJ (US); Robert A. Grimm, Columbus, OH (US)

Correspondence Address: COLGATE-PALMOLIVE COMPANY, 909 River Road, P.O. Box 1343, Piscataway, NJ, 08855-1343, US

(73) Assignee: Colgate-Palmolive Company

(21) Appl. No.: 09/992,788

(22) Filed: Nov. 14, 2001

(51) Int. Cl. A46B 5/00; A46D 3/00; B29C 65/10

(52) U.S. Cl. 15/167.1; 15/143.1; 15/159.1; 300/21; 156/304.6

(57) ABSTRACT

A consumer acceptable toothbrush and method of forming same, composed of a preformed components, which components are welding together by applying a hot gas to an end of each component until the surface of each end is molten, and bringing said molten ends together within a mold having the desired shape of the portion of the toothbrush being welded.

### FIELD OF THE INVENTION

The present invention relates to toothbrushes, and more particularly, to a toothbrush and a method of manufacture of toothbrush thereof, wherein pre-formed toothbrush components, including heads, necks and/or handles, are thermally welded together using a hot gas to form strongly joined toothbrush bodies with acceptable consumer aesthetics.

### BACKGROUND OF THE INVENTION

Conventional toothbrush bodies comprise a generally elongated rod, that functions as a handle, which may have a straight or curved neck section connected to a head, which head has a face which is typically a flattened section to which tufts of bristles are fastened. Such toothbrush bodies are generally manufactured of a thermoplastic material, in a one step injection molding process wherein, the thermoplastic material is heated to a molten state and injected under pressure into a steel mold of the toothbrush body. After the plastic solidifies, the mold is opened and the fully formed toothbrush body is removed, ready for tufting. Such a conventional toothbrush body, formed of one material, does not provide the desired coloration alternatives and range of physical characteristics possible with toothbrush bodies having heads, necks, handles and parts thereof manufactured of different materials. For example, it is often desirable to have a more rigid handle for controlling the manipulation of the toothbrush, joined to a less rigid, i.e. more flexible, head or neck portion that will yield during brushing and so tend to reduce gingival trauma associated with excess brushing pressure by the user.

During brushing, the joint or joints formed when assembling a toothbrush from any preformed components, i.e. toothbrush heads, necks, handles and parts thereof will be subjected to significant torque perpendicular to the longitudinal axis of the toothbrush, the so-called “peel force”. This peel force is a result of the opposed and counteracting forces applied to the brush head against the teeth and handle by the hand of the user. These counteracting forces are magnified by the lever principle, which results from forces being applied at a distance along the elongated length of the toothbrush relative to the joint wherein their effect is experienced. Prior efforts to manufacture joints having sufficient peel resistant strength to resist such peel forces, that is peel resistant joints, have involved the use of mechanical interlocks between the parts being joined. But, such mechanical interlocks have been unable to provide the aesthetics possible in a conventionally molded, unitary toothbrush body, specifically a clean, smooth surface, with no consumer perceivable distortion or imperfection, such as flash.

U.S. Pat. No. 2,445,657 discloses toothbrush bodies having heads of a resilient material, such as vulcanized rubber, secured to rigid handles. These toothbrush bodies are manufactured in a multi-step process, wherein the heads and handles are separately produced and subsequently cemented together. Such cementing, or in general adhesive bonding, requires surface preparation and a time interval for the adhesive to cure or otherwise set, adversely effecting the economics of mass production. Further, while the bond formed may have acceptable aesthetics, it will not provide sufficient peel resistance to withstand long term consumer use.

U.S. Pat. No. 6,066,282 discloses a process of making a toothbrush wherein a handle is molded about a pin, stud or other engagement part extending from a preformed toothbrush head. This process does not provide a sufficiently peel resistant joint due to the fact that the flow of the molten handle material about the cold engagement part of the preformed head does not sufficiently melt the cold engagement part to form a sufficiently strong bond therebetween.

U.S. Pat. No. 6,220,673 discloses the use of lasers to weld preformed toothbrush head and handle components, wherein a laser beam of a particular wavelength penetrates one of the thermoplastic components that is transparent to the particular laser wavelength and is absorbed, heats, and melts the second component or a third material located between the two components, to bond the two components together. To facilitate such a joining the materials being joined must have similar melt temperatures and flow properties, or the lower melt rate material melts and flows, preventing the generation of sufficient heat to properly melt the higher melt temperature material for creation of a strong bond therebetween. Accordingly, it has previously been known that to be weldable, materials must have fairly close melt flow rates differing by no more than 2 to 4 g/10 min. As mentioned above, even with materials of similar melt flow rates, the joint formed by the heating of one component to melt the second does not provide sufficient flow and intermingling of materials to form a strong enough bond to withstand the average peel forces that a toothbrush is subjected to in day-to-day use for a prolonged period.

The September/October 2001 TWI Connect Magazine, Issue 114, published by TWI, Ltd., of Cambridge, England CB1 6AL, discloses on pages 4-5, an alternative technique of welding thermoplastic components using hot gas as a welding medium. The hot gas welding process typically involves forming a seam to be joined by aligning the work pieces in a V-butt or T-butt configuration and hot gas melting both the seam and a consumable filler rod of the same polymer type. The weld is formed from the melting and fusing of the abutting work pieces and the filler material to form a seam which will contain distortions, flash and other imperfections that are not consumer acceptable in a toothbrush. Further, this process while involving more economical equipment than lasers is disclosed as being slow and of varying quality depending upon the skill of the operator. Also, until this time it has been known that, when welding with hot air as the hot gas, certain thermoplastics such as polypropylene oxidize and structurally weaken.

There is a need in the art for an economical means of providing a toothbrush of preformed head, neck and/or handle components and parts thereof, which toothbrush is manufactured with joints of acceptable peel resistant strength, and acceptable consumer aesthetics, i.e. without any degradation, distortion, imperfections, flash or misalignment.

### BRIEF SUMMARY OF THE INVENTION

The present invention encompasses an aesthetically acceptable toothbrush and economical method of manufacture thereof, said toothbrush being formed from at least two preformed components which are welded together, which components include at least part of a head, a neck, a handle and combinations thereof; wherein, said components are welded together with welds that surprisingly having a peel resistant strength of from 40 to over 100% greater than the peel resistant strength of corresponding laser welds of the same components. The method of manufacture of said toothbrush is composed of the steps: (1) heating with a hot gas at least a portion of the ends of said two or more preformed toothbrush components until the entire surface of said end portions melt; (2) joining said ends together within a mold having the desired shape of the segment of said toothbrush being joined, and (3) cooling said joined ends to complete the desired welding. The hot gas is preferably air, carbon dioxide, nitrogen, neon or argon and combinations thereof, and most preferably air.

When the preformed toothbrush components being joined by the present invention are of materials with significantly different melt flow rates, it is preferred that the heating of each of the respective ends of the materials being joined be from different hot air sources, at different temperatures and air flow rates. Use of such different heating conditions for each respective component facilitates their effective joinder, even when the components have melt flow rates differing by more than 5 g/10 min. and up to differences of 100 g/10 min. or greater, in a commercially acceptable time interval of from about 2 to about 10 seconds per toothbrush. Further, within such a commercially acceptable time interval, the application of hot air to oxidizable polyproplyene thermoplastics does not noticeably weaken such thermoplastics.

### BRIEF DESCRIPTION OF THE DRAWINGS

For a fuller understanding of the nature of the invention, reference the following detailed description, taken in connection with the accompanying drawings in which:

FIG. 1 is a perspective view of a first embodiment of the components of the present method invention, showing a preformed head component 10 and a preformed handle component 12 to be joined, by exposing the respective ends of each preformed component 14, 16 to heated air from two independent hot air sources 18, 20 and bringing the ends together within a fixture comprised of an upper section 22 and a lower section 24.

FIG. 2 is a perspective view of the components of the present method invention, showing a preformed head component 10 mated to a preformed handle component 12, which mated components are intimately surrounded by a fixture comprised of an upper section 22 and a lower section 24. The hot air sources 18, 20, used to heat the ends prior to their being mated together, are shown withdrawn from the preformed head components 10, 12, so as to allow the preformed components 10, 12 to be mated and intimately surrounded by said fixture.

FIG. 3 is a perspective view of a preformed toothbrush components, a preformed head 10 and a preformed handle 12, with their ends 14, 16 aligned to be bonded.

FIG. 3A is an enlargement of the ends 14, 16 of FIG. 3, wherein the ends 14, 16 are angled to form a scarf joint when they are brought together.

FIG. 3B is a second and alternative embodiment of the angled ends of FIG. 3A, wherein one end 16 has a build-up of material thereon and the other end 14 has a recess, hole or depression therein, corresponding to the build-up on the other end 16. The corresponding build-up and recess providing a mechanical interlocking joint, with increased surface area, for enhanced strength.

FIG. 3C is a third alternative embodiment of the angled ends of FIG. 3B, wherein both ends 14, 16 each have a central build-up of material thereon to provide greater material surface area exposure to the heat source for quicker melting, greater material flow and intermingling for a stronger joint that is formed faster. Further, by locating the build-up centrally within the work surface of the parts to be joined, as the buildup material melts and flows and as the parts are forced together in the joining process and constrained by a fixture, the material will fill-in the joint and conform to the desired joint shape.

### DETAILED DESCRIPTION OF THE PREFERRED EMBODIMENT

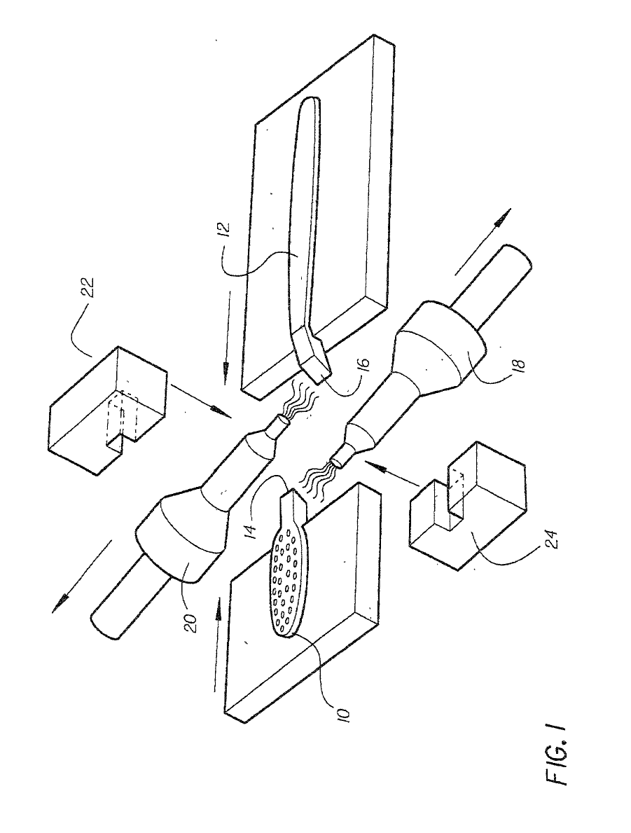

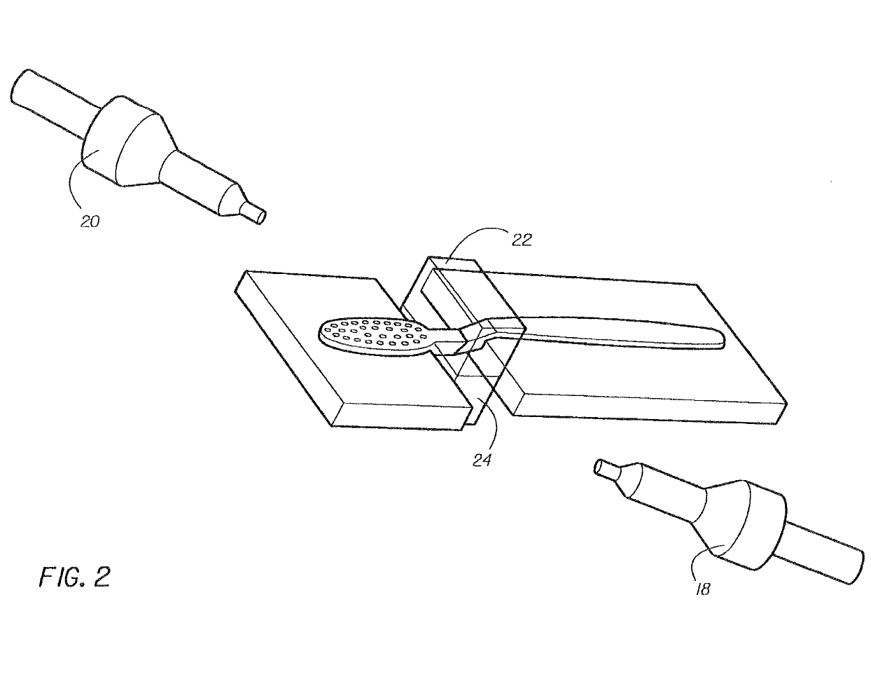

Reference is made to FIG. 1, showing a perspective view of the components of a first embodiment of the present method invention, wherein a preformed toothbrush head component 10 and a preformed toothbrush handle component 12 are joined by heating their respective ends 14, 16 with hot air provided by independent hot air sources 18, 20, until the respective ends 14, 16 are melted past their softening points until the entire surface of said ends 14, 16 melts, such that when they are brought together and intimately surrounded by a fixture 22 24 having the shape of the desired part of the toothbrush being joined, i.e. a mold form. FIG. 2 shows the positioning of the ends 14, 16 within the fixture such that as they flow and bond together the joint will be free of any degradation, distortion, imperfections, flash or misalignment. While in this first embodiment of the present method invention a toothbrush head component is shown as being joined to a toothbrush handle component, any two or more preformed components or segments of a toothbrush can be joined one to another, including for example a preformed head component, to a preformed neck component, to a preformed handle component.

If the preformed thermoplastic toothbrush components to be joined have similar physical and chemical characteristics, i.e. melt flow rates differing by 4 g/10 min. or less, a single hot air source can be used to provide the hot air necessary to melt the ends thereof for bonding together. However, if the preformed toothbrush components do not have similar physical and chemical characteristics, i.e. melt flow rates differing by 5 g/10 min. or more, two or more independent hot air sources should be used to provide the different temperature hot air necessary to melt each particular component material. Such use of independent hot air sources in the present invention allows preformed head, neck, handle and/or parts thereof components, having significantly different material flow rates to be welded together with acceptable aesthetics.

As stated above, surprisingly, the peel resistant strength of the hot air welds of the present invention provide joints which are 40 to over 100% greater in peel resistant strength than comparable welds of the same materials made by laser welding. This increase in weld peel resistant strength was established by impact testing of comparable polypropylene head joined mid-neck to comparable polypropylene toothbrush handle components, the components welded by laser and the present hot air welding process. The testing the weld peel resistant strength utilized a test method similar to that of the American Society for Testing and Materials (ASTM), Testing Method D4812-99; except, the head of each toothbrush being tested was encased in a 2 inch (5.08 cm) fixture with a flat impact face, which face was impacted by at the middle of the brush head by a hammer to deliver at least 100 in-lbs. (11.30 joules) of force, and the toothbrush handle was clamped 2.5 inches (6.35 cm) from the point of impact of the hammer, below the weld joint of the head to the handle in the brush neck. A preferred impact tester used to measure the break force of the weld, is a Pendulun Impact Tester Model 92T, manufactured by the Tinius Olsen Testing Machine Company, Inc., of Willow Grove, Pa. 19090. The average break force recorded by the impact tester for the laser joints was about 10.8 in-lbs. (1.22 joules), significantly below an acceptable break force or peel resistant strength of 15 in-lbs. (1.69 joules) required for long term consumer use. In comparison, the average break force for hot air joints formed by the process of the present invention was over about 18 in-lbs (2.03 joules) and up to on average over 20 in-lbs. (2.26 joules), most samples exhibiting a break force in the range of about 22 (2.49 joules) to about 24 in-lbs. (2.71 joules); significantly over the acceptable strength necessary for long term consumer use.

In the present process invention, the preformed neck and/or head component or parts thereof may be made of a thermoplastic elastomeric (TPE), a thermoplastic olefin (TPO), a soft thermoplastic polyolefin (e.g. polybutylene) or other elastomeric material such as ethylenevinylacetate copolyer (EVA) or ethylene propylene rubber (EPR) to reduce the pressure of brushing and corresponding wear of the soft oral tissues. Acceptable TPE materials include styrene-ethylene/butylene-styrene (SEBS) type styrene block copolymers, such as styrene-butadiene-styrene, styrene-isoprenestyrene, and related copolymers, as well as, thermoplastic polyurethane (TPU) or a thermoplastic vulcanate (TPV) which consists of a mixture of polypropylene and EPDM (ethylene propylene diene monomers) which is available as Santoprene (brand), described in U.S. Pat. No. 5,393,796; or Vyram (brand), anther TPV consisting of a mixture of polypropylene and natural rubber, both Santoprene and Vyram being elastomers marketed by Advanced Elastomer Systems LP, Akron, Ohio 44311. Another and preferred TPE, a styrene block copolymer, is Dynaflex G6713 (brand), marketed by GLS Corp., Cary, Ill. 60013. If a substantially clear appearance is desired, certain TPE or TPUS or ethylene vinyl acetate (EVA) materials can be used. These and other suitable elastomers have, typically, a Shore A hardness of from about 3 to about 80 and preferably, about 10 to about 40.

Alternatively, in the present process invention, the preformed head, neck and/or handle component or components can be manufactured of a variety of less flexible thermoplastic materials and blends thereof, including polyproplyene and polyester materials, such as polyethylene terephthalate or a copolyester, such as PCTA polyester or SAN, or a cellulosic plastic, such as cellulose acetate propionate (CAP). A preferred polypropylene block-copolymer preformed head component, with a good combination of high impact strength and stiffness for enhanced tuft retention can be used is Stamylan P, available from DSM Petrochemicals, 6130 AA Sittard, The Netherlands, having a melt flow index of 37 g/10 min. This preformed polypropylene block-copolymer head component may be joined to a preformed handle of any standard toothbrush grade polypropylene material, preferably a lower cost polypropylene homopolymer having a melt flow rate of about 4 g/10 min., such as Huntsman Polypropylene P4G3Z-039, available from Huntsman Corporation, Longview Tex. 75603.

A particularly preferred embodiment of the present invention is a toothbrush comprising a preformed relatively rigid head 10 and handle 12, with an flexible elastomeric component in the neck, which component flexibly links said head 10 to said handle 12. The elastomeric component in the neck may be weld by the method of the present invention to the head 10 and handle 12 or it may be molded first in a molding process wherein the head 10 or handle 12 is subsequently molded thereto and the other component joined by the method of the present invention.

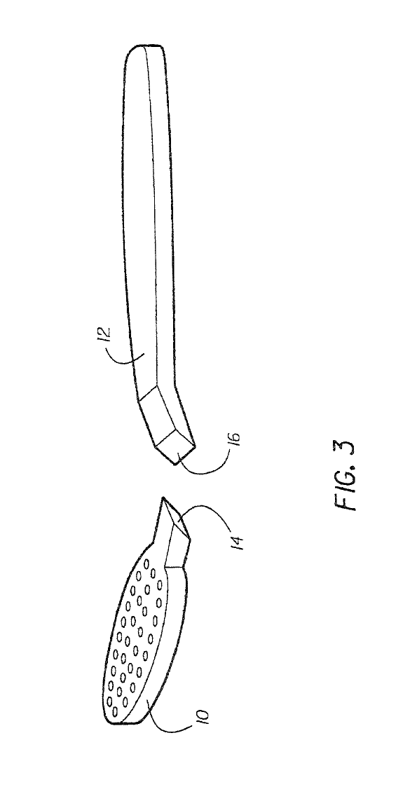

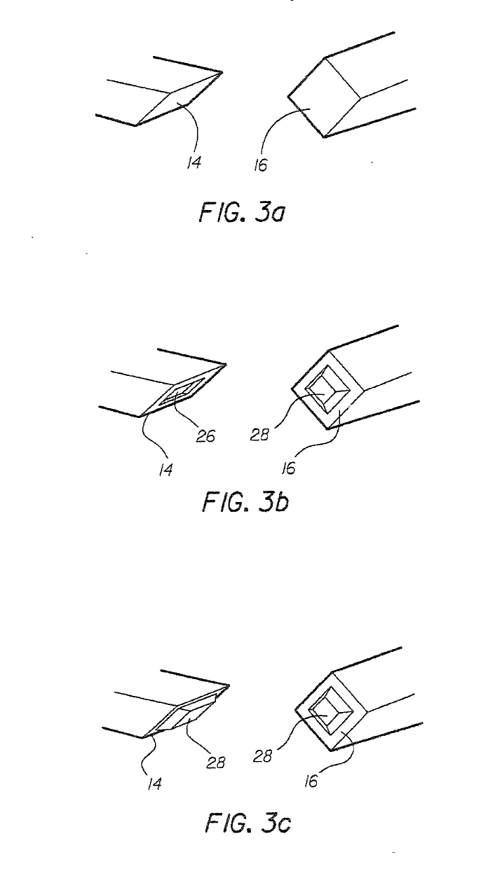

As shown in FIG. 3 ends 14, 16 of the preformed components to be joined together with the present method invention are preferably provided with complementary chamfers or angles (as shown in FIG. 3, angles alpha and beta) with respect to each other, i.e. to provide a scarf joint, such that the surface area being joined is increased for a stronger joint. Further, as shown in FIG. 3B, it is preferred that the angled surface of one end 16 contains a raised portion in the middle thereof. i.e. an excess build-up of material 28 and the surface of the other end 14 is correspondingly recessed 26, the recess 26 preferably being in the form of a hole of from 1-2 mm in diameter and 2 mm deep; such that, the surface area being joined is further increased to form a still stronger joint. As shown in FIG. 3C, in a still more preferred embodiment the angled surface of both ends 14, 16 both contain a build-up of excess material 28, such that when the ends 14, 16 are brought together to bond within, and intimately surrounded by a fixture or mold 22, 24, the bond formed has a surprisingly good appearance, i.e. free of distortion, imperfections, flash or misalignment.

In the method of the present invention the hot gas is applied to the thermoplastic ends of the preformed toothbrush components for bonding thereof from at least one hot gas source 18, 20 , at a temperature of from about 200 to about 450 degrees Celsius, preferably 300 to about 400 degrees Celsius, until the first signs of a liquid appear thereon, i.e. the thermoplastic surface to be joined melts. The hot gas is forced from a hot gas source 18, 20 at a flow rate of from about 2 to 30 m/sec., preferably 5 to 20 m/sec., and most preferably 7 to 15 m/sec.; out of a round or preferably oval nozzle with a diameter or larger dimension of from about 2 to about 10 mm, preferably 2 to 6 mm. The ends of the preformed toothbrush components are located 2 to 10 mm and preferably from 3 to 5 mm from the hot air source. Which combination of hot gas temperature, flow rate, size of hot air orifice and location from the thermoplastic components to be heated to a temperature for bonding thereof, is important to obtain commercially acceptable times of from about 1 to about 4 seconds for raising the work pieces to the desired temperature for bond formation. While use of various hot gases such as air, carbon dioxide, nitrogen, neon and argon and combinations thereof are preferred, air is the most preferred hot gas for economical reasons. Particularly preferred hot air sources 18, 20 are commercially available from Leister Process Technologies, Riedstrasse, CH-6060 Sarnen, Switzerland, under the tradenames Hot Jets S (brand) with a build-in blower, or Labor S (brand) welding tools; which Labor S (brand) welding tools can be used in conjunction with an external Robust High Pressure Blower. The hot air source 18, 20 nozzles are preferably oval in configuration, with a larger diameter of about 3 to 10 mm, preferably about 5 mm.

In the present invention, the preformed toothbrush components are held mechanically in place while the respective ends thereof to be joined are heated to the proper temperature for bond formation, i.e. sufficient temperature to melt each end to a state wherein the entire surface thereof is completely covered by a thin liquid film and the material of each will flow and intermix with that of the other to which it is being bonded. After the subject ends 14, 16 reach the proper temperature for bonding, the heat source is removed and the ends 14, 16 are quickly brought together by mechanically means, i.e. in a fraction of a second. As the ends 14, 16 are brought together, they are simultaneously enclosed within a fixture or mold 22, 24 which intimately surrounding joint portion and has an internal shape of the desired completed joint section of the toothbrush. The ends 14, 16 and parts of the mold 22, 24 are preferably pressed together with a force of at least 4 and preferably at least 6 bar, until the desired joint is formed and cools sufficiently to allow separation of the mold parts 22, 24 without separation of the joint, a period of about 1 to 4 seconds, such that the total period for heating the respective ends, forcing said ends together and maintaining them together within the mold is about 2 to about 10 seconds and preferably about 2 to about 8 seconds.

The fixture or mold 22, 24 which in the present invention encases the two thermoplastic end 14, 16, sections being joined as stated above, provides a mold within which the molten joint conforms to form a consumer acceptable joining. Such a mold and the simple mechanism to position and reposition the thermoplastic end 14, 16 sections can be obtained from numerous machine shops and mold suppliers, including Machines Boucherie N.V., Izegem, Belgium; Anton Zahoransky GmbH & Company, Todtnau, Germany and/or Foboha GmbH, Haslach, Germany.

What is claimed is:

1. An aesthetically acceptable toothbrush manufactured from preformed components comprising:
the toothbrush formed from at least two preformed toothbrush components, which are welded together to form a toothbrush having acceptable peel resistant strength; said preformed toothbrush components being selected from the group consisting of at least a part of a head, a neck and a handle, and combinations thereof.

2. The toothbrush of claim 1, wherein said weld has a break strength to withstand a peel force of at least 15 in-lbs. (1.69 joules).

3. The toothbrush of claim 1, wherein said weld has a break strength to withstand a peel force of at least 18 in-lbs. (2.03 joules).

4. The toothbrush of claim 1, wherein said weld has a break strength to withstand a peel force of at least 20 in-lbs. (2.26 joules).

5. The toothbrush of claim 1, wherein said at least one of said components is elastomeric.

6. The toothbrush of claim 1, wherein a head and a handle are welded by heating each respective component with hot air.

7. The toothbrush of claim 1, wherein three preformed components or parts thereof are welded together to form said toothbrush.

8. The toothbrush of claim 7, wherein at least one of said preformed components is elastomeric.

9. An aesthetically acceptable toothbrush manufactured from preformed components comprising:
the toothbrush formed from at least two preformed toothbrush components, which are welded together to form a toothbrush; said preformed toothbrush components being selected from the group consisting of at least a part of a head, a neck and a handle, and combinations thereof, wherein said components are of different thermoplastic materials having melt flow rates which differ by more than 5 g/10 min.

10. The toothbrush of claim 9, wherein at least one of said components is elastomeric.

11. A process welding preformed thermoplastic toothbrush components to form a toothbrush, the process comprising,
(a) heating, with a hot gas, the ends of two or more preformed toothbrush components, which components are selected from the group consisting of at least a part of a head, a neck and a handle or combinations thereof, until at least a portion of each of said ends melts;
(b) joining said ends together within a mold having the desired shape of that respective section of said toothbrush;
(c) cooling said joined ends to complete the desired welding.

12. The hot gas welding process of claim 11, wherein the hot gas is applied from a single source to the end of each component to be joined.

13. The hot gas welding process of claim 11, wherein the hot gas is applied to the end of each component to be joined from a different hot gas source.

14. The hot gas welding process of claim 13, wherein the preformed toothbrush components are of materials which differ in melt flow rates by at least 5 g/10 min.

15. The gas welding process of claims 11, 12, 13, and 14 in which the hot gas is selected from the group consisting of air, carbon dioxide, nitrogen, neon and argon and combinations thereof.

16. The hot gas welding process of claim 11, wherein said toothbrush head and/or neck component or components may be a thermoplastic elastomeric material, selected from the group consisting of styrene-butadiene-styrene, styrene-isoprenestyrene, thermoplastic polyurethane and thermoplastic vulcanate materials.

17. The hot air welding process of claim 11, wherein the welded components are welded with a break strength to withstand a peel force of at least 18 in-lbs. (2.03 joules).

18. The hot gas welding process of claim 11, wherein said ends of the said toothbrush components to be welded are chamfered to form a scarf joint when welded one to the other.

19. The hot gas welding process of claim 11, wherein one of ends of the toothbrush components to be welded has a build-up of material central thereof and the end of said second component has a hole therein.

20. The hot gas welding process of claim 11, wherein said hot gas is applied to said toothbrush component ends at a temperature of from 200 to 450 degrees Celcius.

21. The hot gas welding process of claim 20, wherein said temperature is from 300 to 400 degrees Celcius.

22. The hot gas welding process of claim 11, wherein said hot gas if applied to said ends of the components to be welded together from said hot gas source at a flow rate of 2 to 30 m/sec.

23. The hot gas welding process of claim 11, wherein said hot gas is applied to said ends of the components to be welded together from said at least one hot gas source which is located from 2 to 10 mm from said ends.

24. The hot gas welding process of claim 11, wherein said hot gas is applied to said ends of the components to be welded together from said at least one hot gas source which source has an oval nozzle, with a larger diameter of from 2 to 10 mm.

25. The hot gas welding process of claim 11, wherein the ends of the components being welded are pressed together with a force of at least 4 bar within said mold which compresses said ends with a force of at least 4 bar.
